(19) United States
(12) Patent Application Publication
(10) Pub. No.: US 2003/0132398 A1
(43) Pub. Date: Jul. 17, 2003

(54) System, apparatus and method for killing bacteria and viruses in mail items

(76) Inventor: Xiaoling Wang, Princeton Junction, NJ (US)

Correspondence Address: Mr. Walter J. Tencza Jr., Suite 3, 10 Station Place, Metuchen, NJ, 08840, US

(21) Appl. No.: 10/001,504

(22) Filed: Nov. 21, 2001

(51) Int. Cl. B01J 19/08

(52) U.S. Cl. 250/492.1; 422/186

(57) ABSTRACT

The present invention discloses an apparatus and method for safely radiating mail to eliminate bacteria and viruses comprised of a metal detection device and a microwave device. The metal detection device determines whether a mail item contains metal. If the mail item does not contain metal, the mail item is subject to radiation by the microwave device. The apparatus may also include a conveyor device for transporting a mail container, including a plurality of mail items, into the metal detection device and into the microwave device if no metal is detected within the mail container. A bypass conveyor device may also be provided for transporting the mail container away from the microwave device if metal is detected in the mail container. The present invention may also include a smoke or fire detection device, a temperature sensing device, and/or a fire extinguishing device for situations when metal is accidentally radiated.

### FIELD OF THE INVENTION

This invention relates to systems and methods for killing bacteria and viruses.

### BACKGROUND OF THE INVENTION

Currently, the United States is under attack from bio-terrorism using mail items. Anthrax may be just the beginning. Even more serious forms of bio-terrorism attacks using the United States Postal Service or mail items may follow. Since mail items can physically be delivered to anyone at anytime and anywhere, the bio-terrorist using the mail can potentially lead to a mass panic situation and dramatically limit our freedom and reduce our productivity due to the additionally needed security checks for preventing bio-terrorism attacks. This is a very serious, very urgent and potentially very damaging threat to our society and our way of life. We must fight back quickly!

Since most mails are received and distributed by postal offices and a limited number (a few hundred) of mail Production and Distribution Centers, if bio-germs can effectively be killed at the postal offices or at those centers, the bio-germ spreading may effectively be stopped. Since this is a totally new challenge to our society, no prior art has been found.

### SUMMARY OF THE INVENTION

Although there are many different methods for killing bio-germs, there are a limited number of methods suitable for postal use. The following reasons make the bio-germ killing process for mail applications somewhat unique:

(1) Mail items or pieces should not be damaged and their appearances should not be altered.

(2) The germs may be packed within many layers of papers that may make the penetration difficult for some radiation sources.

(3) The killing process should be fast enough so that a large quantity of mail may be processed quickly.

Although a lot of chemicals may easily kill the bacteria and viruses in mail, they are in general difficult to apply without destroying or altering the mail items or pieces significantly.

In order to not damage or alter the appearance of the postal mail to be processed, a wide range of radiation rays and particle beams, such as Gamma and Xrays, electron or proton beams, Ultra-Violet (UV) light, Infra-Red (IR) light, and Microwaves, may be used to kill the dangerous bacteria and viruses in mail. For achieving a better success rate of killing bacteria and viruses in mail items, a combination of the rays, waves, and heat may be used.

In general, Gamma and high-energy X rays, electron or proton beam based systems can easily penetrate layers of paper and kill most germs quickly. The drawbacks of such systems are the high cost and the danger of radiation. A typical system based Gamma and high-energy X rays, electron or proton beams, may cost far over one million US dollars. That is too costly to be used in a large number of postal offices. In addition, due to radiation protection concerns, such a system may need specially constructed rooms as well as trained workforces, which make the operation of such a system also very expensive. Therefore, these systems may only be suitable for a small number of postal production and distribution centers.

Although powerful Ultra Violet rays may also kill most germs, the germs may only be killed if they are directly exposed to powerful Ultra Violet rays for a certain or preset period of time. However, unlike the gamma rays, high-energy X rays and electron beams, the penetration depth of UV rays is generally small. If the germs are packed deep inside of a thick mail envelope, they may not be killed due to insufficient direct exposure to UV rays.

Infrared beams may not kill germs directly through radiation, but they may generate enough heat to kill germs indirectly through heat. However, they have two drawbacks. First, the killing process with heating is relatively slow. That means a system using infrared beams may need a relatively long time to kill germs completely especially if they are packed deep inside of mail packages. Second, the infrared beams may cause mail items to over heat and that may lead to a fire. This is certainly a very intolerable drawback for postal offices.

The present application therefore proposes a microwave based system and method that can be produced inexpensively, operated and maintained easily and inexpensively. The proposed microwave based system and method can be used at both postal offices and postal production and distribution centers.

The present invention in one or more embodiments provides a low cost solution for killing bio-germs at postal offices and/or at mail production and distribution centers so that bio-germs may be killed before they get to the intended mail recipients.

It is an object of the invention that the disclosed bio-germ killing systems and methods are not germ-specific so that many different types of bio-germs may be killed effectively with the same systems and methods.

It is another object of the invention that the disclosed bio-germ killing systems and methods are inexpensive and easily to produce, to operate and to maintain so that they can be used by postal offices and postal production and distribution centers.

It is yet another object of the invention that the disclosed bio-germ killing systems and methods do not damage mail items and do not change the appearance of the original mail items significantly.

It is yet another object of the invention that the disclosed bio-germ killing systems and methods do not take a very long time to kill bacteria and viruses so that the regular mail delivery schedules are not greatly impacted.

It is yet another object of the invention that the disclosed bio-germ killing systems and methods do not cause additional hazards, especially fire.

### BRIEF DESCRIPTION OF THE DRAWINGS

FIG. 1 shows a perspective view of an apparatus including a metal detection device, a microwave device, and a conveyor device in accordance with one embodiment of the present invention;

FIG. 2 shows a perspective view of an apparatus including a metal detection device, a microwave device, a first conveyor device, and a second conveyor device with a pushing device in accordance with another embodiment of the present invention;

FIG. 3 shows a perspective view of a microwave device which includes a smoke/fire detection device, a fire extinguishing device, and a temperature sensing device;

FIG. 4A shows a perspective view of first and second conveyor devices with a slightly recessed rotation device in a first state;

FIG. 4B shows a perspective view of the first and second conveyor devices and rotation device of FIG. 4A in a second state;

FIG. 5 shows a perspective view of a weight-determining device integrated with a ingress conveyor device; and

FIG. 6 shows a perspective view of a range-sensing device which may be used to determine the fullness of an incoming mail container.

FIG. 7 shows a perspective view of a microwave device which includes a plurality of microwave generation devices; and

FIG. 8 shows a perspective view of a microwave device which includes a steam generation device and an air exchange device.

### DETAILED DESCRIPTION OF THE INVENTION

This invention relates to systems and methods for killing dangerous bacteria and viruses distributed using the mail.

Due to the specific needs mentioned previously for both postal offices and postal production and distribution centers, the present invention provides a microwave based system and method that can be produced inexpensively, operated and maintained easily and inexpensively. However, if some metal sheets, such as aluminum sheets, are present in a piece of mail, a powerful microwave device may cause them to overheat and may cause a fire quickly. Therefore, it is very essential to detect metal sheets, if any, before starting the microwave radiation in order to prevent a fire. In addition, it is also important to have a smoke and fire detection device to detect a fire early and use a fire extinguishing device to eliminate a fire when needed.

A method for safely radiating mail using microwaves in its simplest form may be outlined as follows: An operator uses a metal detection device, which may be handheld or non-handheld, to first determine if a certain amount of mail items, for example the amount of mail items that can easily fit into a mail container, are free of metal pieces. If yes, the operator will then put the mails into a microwave device and select the suitable duration and power level to radiate the mail items with a sufficient amount of microwave energy for killing possible bacteria and viruses. The microwave device may be similar to those commonly used for home cooking purposes in principle but possibly bigger and/or more powerful. If metal pieces have been detected, the operator will find and take out those mails with metal pieces and then put the rest of mail items without metal pieces into the microwave device for radiation. Although this method works in principle, it is not the most efficient method due to required manual operations such as metal detection, transporting mail items in and out of the microwave device.

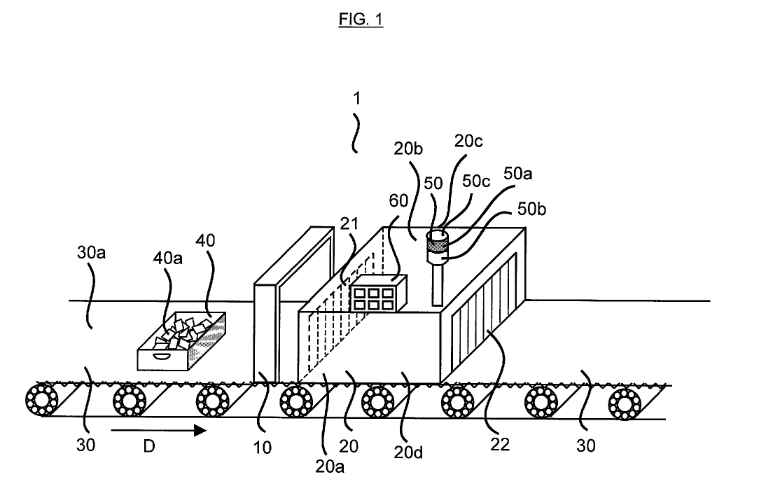

FIG. 1 shows a perspective view of an apparatus 1 in accordance with a first embodiment of the present invention. The apparatus 1 includes a metal detection device 10, a microwave device 20, a conveyor device 30, a system state indication device 50, and a system control device 60. The microwave device 20 has a substantially sealed chamber 20a which is enclosed within ceiling 20b, side walls 20c and 20d, ingress door 21 and egress door 22. FIG. 1 also shows a mail container 40 which includes a plurality of mail items, such as mail item or letter 40a.

The metal detection device 10 is able to detect metal pieces and metal sheets, if any, in mail items, such as the mail items in container 40. The microwave device 20 is able to kill bacteria and viruses, if any, in mail items. The conveyor device 30 transports mail containers, such as mail container 40 and mail items, such as mail item 40a, through the metal detection device 10 and though the microwave device 20.

In operation, a mail container 40 is placed on the conveyor device 30 at location 30a. The conveyor device 30 transports the mail container 40 into and through the metal detection device 10. If metal is detected by metal detection device 10, the metal detection device 10 sends a signal to the system control device 60 to report the presence of metal in the mail container 40. The metal detection device 10 may be electrically connected to the system control device 60 in a wireless manner, in a hardwired manner, or in any other known manner. The system control device 60 will immediately change the state of the system state indication device 50 from a normal operation state to a warning or stopped operation state. The system control device 60 is electrically connected to the system state indication device 50 in any known manner. In this stopped operation state the system control device 60 will stop the conveyor device 30 and prevent the opening of, or close the ingress door 21 of the microwave device 20.

The system state indication device 50 can provide both visual and audio state indications. For example, it may light up a green light 50a when the system is working normally (i.e. when no metal piece has been detected), and flash a red light 50b and/or generate a warning sound from a speaker 50c when it detects the presence of metal in mail container 40. When an operator sees the flash of the red light 50b or hears the warning sound from speaker 50c, he or she may remove the mail container 40 containing one or more mail items with metal pieces, and may restart the apparatus 1 for processing another mail container, which may be similar to mail container 40, only with different mail items.

The system state indication device 50 and the system control device 60 may be placed in various locations. For example, devices 50 and 60 may be placed together with or near the microwave device 20, as shown in FIG. 1. Devices 50 and 60 may also be placed separately or together with or near the metal detection device 10 or elsewhere. By preventing metal pieces from getting into the microwave device 20, metal burning under powerful radiation of microwave device 20 can be prevented. The operator may use a hand-held metal detector to locate the mail items containing metal pieces and remove them from the mail container 40 and the mail container 40 can then be put back again on the conveyor device 30 for further processing.

If the mail container 40 does not include any metal, the mail container 40 passes through the metal detection device 10 and then into the microwave device 20 through the ingress door 21. The microwave device 20 kills bacteria and viruses, if any, in the mail container 40. The mail container 40 is transported through the microwave device 20 and out the egress door 22 by the conveyor device 30. At this point the mail container 40 and the mail items, such as mail item 40a are now free of bacteria and viruses, and can be safely delivered.

The system control device 60 is electrically connected to and controls the operations of the conveyor device 30, the metal detection device 10, the microwave device 20 and the system state indication device 50. The system control device 60 controls both the ingress door 21 and the egress door 22 of the microwave device.

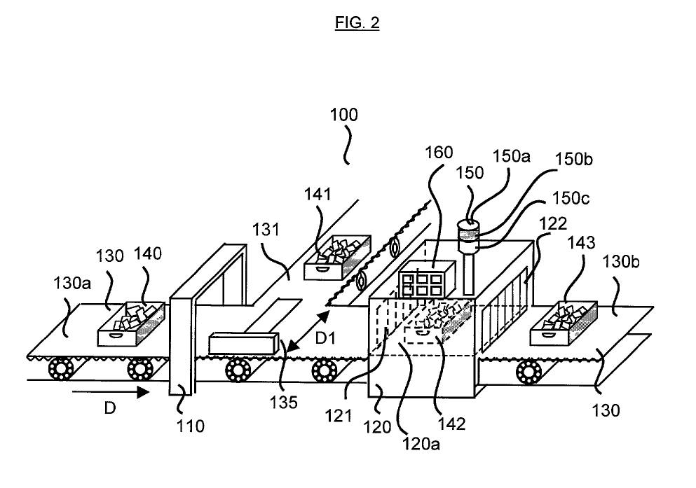

FIG. 2 shows a perspective view of an apparatus 100 including a metal detection device 110, a microwave device 120, a conveyor device 130 comprised of an ingress conveyor device 130a, and a egress conveyor device 130b, and a pushing device 135 in accordance with another embodiment of the present invention. The metal detection device 110 and the microwave device 120 may be similar to or the same as metal detection device 10 and microwave device 20 shown in FIG. 1. FIG. 2 also shows mail containers 140, 141, and 142, which are each similar to or the same as container 40 in FIG. 1. Apparatus 100 includes a system state indication device 150, and a system control device 160, which are similar to or the same as device 50, and device 60, respectively, shown in FIG. 1. The microwave device 120 includes ingress door 121 and egress door 122 similar to door 21 and 22, respectively of FIG. 1. The system state indication device 150 includes components 150a, 150b, and 150c which may be the same as 50a, 50b, and 50c, respectively of the FIG. 1 embodiment.

The ingress conveyor device 130a transports mail containers, such as container 140 into the microwave device 120 while the egress conveyor device 130b is responsible for transporting the radiated mail containers, such as container 142 out of the microwave device 120. Both conveyor devices 130a and 130b may be operated together or separately.

The apparatus 100 also includes a bypass conveyor device 131 and a pushing device 135.

The embodiment of FIG. 2 provides for less human operator intervention than the FIG. 1 embodiment. Initially a plurality of mail containers such as container 140,141, 142, and 143 are placed on the ingress conveyor device 130a with a certain minimum distance between any two consecutive mail containers. The ingress conveyor device 130a transports the first mail container, such as mail container 141 through the metal detection device 110. When the metal detection device 110 detects one or more metal pieces in the mail container 141, the system control device 160 will activate the pushing device 135 to push the mail container 141 from the ingress conveyor device 130a onto the bypass conveyor device 131. The system control device may be electrically connected to the bypass conveyor device 131, as well as to devices 110, 120, 130, and 150, similar to the FIG. 1 embodiment.

After the mail container 141 has been pushed off of the conveyor device 130a, the following mail container 142 on the conveyor device 130a will be transported through the metal detection device 110. If no metal is detected in the mail container 142, the ingress door 121 will open for letting the mail container 142 be transported into the microwave device 120. Mail container 142 is shown in dashed lines in FIG. 2, because mail container 142 is within the chamber 120a of the microwave device 120, which is similar to chamber 20a in FIG. 1. The ingress door 121 will be closed after the mail container 142 is completely inside of the microwave device 120. The conveyor device 130a will also be stopped. The system control device 160 will then check if both ingress and egress doors 121 and 122 are completely closed for preventing microwaves from getting out of the microwave device 120. If they are completely closed, it will start to radiate the mail container 142 in the chamber 120a with powerful microwaves for a preset period of time.

After the radiation process is finished, the system control device 160 will open the egress door 122 and move the egress conveyor device 130b again to transport the processed mail container 142 out of the microwave device 120 into the position where mail container 143 is in FIG. 2. Processed mail containers, such as mail container 143 in FIG. 2 may then be transported to a designated storage area or be picked up by operators. It is not necessarily important where to put the system state indication device 150 and the system control device 160. The devices 150 and 160 may be placed for example together with or near the microwave device 120, as shown in FIG. 2. The devices 150 and 160 may also be placed separately or together with or near the metal detection device 110 or elsewhere.

The microwave device 20 and 120 shown in FIG. 1 and FIG. 2 may contain additional components for enhanced safety of the device.

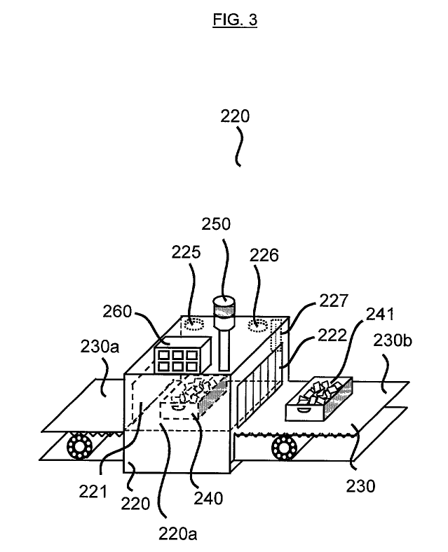

FIG. 3 shows a perspective view of a microwave device 220 which includes a smoke/fire detection device 225, a fire extinguishing device 226, and a temperature sensing device 227. The devices 225, 226, and 227 provide enhanced safety. The microwave device 220 can be used in place of the microwave devices 20 and 120. The microwave device 220 includes an ingress door 221 and an egress door 222 which may be similar to, or the same, as ingress doors 21 or 121 and egress doors 22 or 122, respectively. FIG. 3 also shows conveyor devices 230a and 230b which may be similar to, or the same, as conveyor devices 130a and 130b, system state indication device 250, which may be similar to, or the same as, system state indication devices 50 or 150, and system control device 260 which may be similar to, or the same as, system control devices 60 or 160. Mail container 240 (shown in dashed lines inside the microwave device 220) and mail container 241 shown outside microwave device 220 may be the same or similar to mail containers in previous Figs. of the present application, such as container 40 in FIG. 1.

The smoke/fire detection device 225, may be similar to smoke/fire detectors commonly used for homes and other building. The smoke/fire detection device 225 constantly monitors the mail container, such as mail container 240 in FIG. 3, being radiated by microwaves, for possible smoke and fire. When smoke and/or fire have been detected by detection device 225 within a chamber 220a of the microwave device 220, the smoke/fire detection device 225 sends a fire alarm signal to the system control device 260. The system control device 260 will immediately shut down the microwave device 220 and change the state of the system state indication device 250 from normal to fire and then the system control device 260 will continue to monitor the smoke and fire situation and report to the system indication device 250. If the situation is getting worse (for example the smoke is getting thicker and/or the temperature is getting higher), the system control device 260 will turn on the fire extinguishing device 226 to extinguish the fire within the chamber 220a of the microwave device 220. The fire extinguishing device 226 may be powder or cold steam based for saving as many mail items as possible. Water based systems may not be preferred because they may cause extensive damage to all mail items within a mail container, such as mail container 240. In addition to the smoke/fire detection device 225 and the fire extinguishing device 226, it may also be beneficial to include a temperature sensing device 227 to constantly monitor and report the inside temperature of the microwave device 220 to the system control device 260. When a certain critical temperature has been reached as detected by the temperature sensing device 227, even without the smoke/fire detection device 225 providing a fire alarm signal, the system control device 260 may shut down the microwave power to microwave device 220 and let the temperature drop. If the temperature still increases, this may also indicate a fire situation and the system control device 260 may also turn on the fire extinguishing device 226 to extinguish the fire.

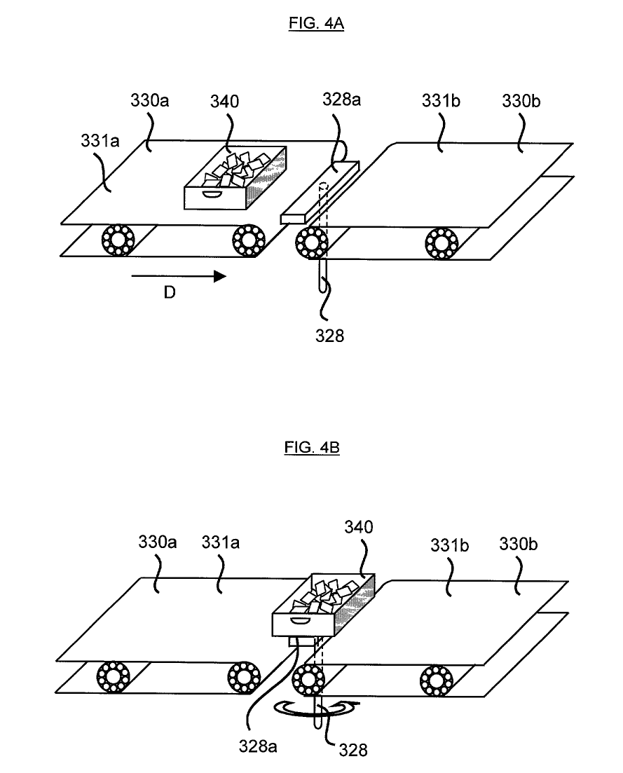

FIG. 4A shows a perspective view of conveyor devices 330a and 330b with a slightly recessed rotation device 328 in a first state. FIG. 4A also shows mail container 340 which may be similar to or the same as for example mail container 40 of FIG. 1. Conveyor devices 330a and 330b may be similar to or the same as conveyor devices of other embodiments of the present invention such as conveyor devices 130a and 130b, respectively.

Just like most microwave ovens used at home, for homogeneous radiation of mail items inside the mail container 340 it may be beneficial to include the rotation device 328 in a microwave device, such as one similar to or the same as microwave device 220 for rotating the mail container 340 inside of a microwave device, such as device 220 when for example the device 220 is radiating the mail container 340. When the conveyor devices 330a or 330b are transporting mail container 340, the rotation device 328 is in its slightly recessed state such that its top surface 328a is slightly below or roughly at the same level as surfaces 331a and 331b of the conveyor devices 330a and 330b. This ensures that the mail container 340 can be transported freely by the conveyor devices 330a or 330b.

When a mail container 340 has been transported to its designated position so that a microwave device, such as device 220 of FIG. 3, can start radiating it, the rotation device 328 will rise its top surface 328a to elevate the mail container 340 above the surfaces 331a and 331b of the conveyor devices 330a and 330b, respectively, as shown in FIG. 4B. After the mail container 340 has been elevated above the conveyor devices 330a and 330b, the rotation device 328 may rotate the mail container 340 freely with a defined speed just like a regular microwave oven does. This ensures a relatively homogeneous microwave radiation of the mail items in the mail container 340.

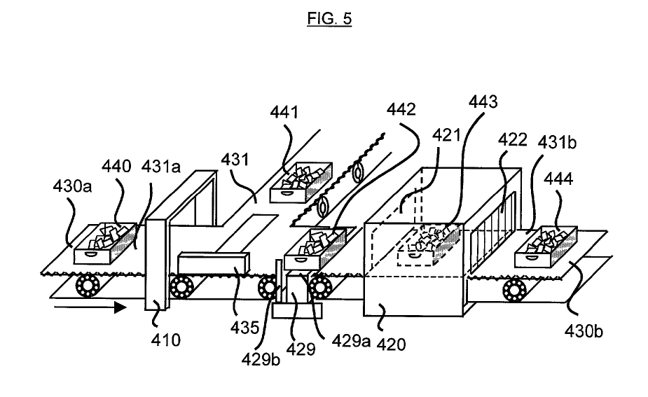

FIG. 5 shows a perspective view of a weight-determining device 429 integrated with an ingress conveyor device 430a. FIG. 5 shows mail containers 440, 441, 442, 443, and 444, which may be similar to or the same as previous mail containers mentioned in this application, such as mail container 40 of FIG. 1. FIG. 5 shows metal detection device 410, and microwave device 420 having ingress door 421 and egress door 422 which may be similar to or the same as previous microwave devices mentioned in this application, such as microwave device 20. FIG. 5 also shows conveyor devices 430a and 430b may be similar or the same as conveyor devices 130a and 130b. Conveyor device 431 may be similar to, or the same as, the bypass conveyor device 131. Also shown in FIG. 5, is pushing device 435 which may be the same or similar to pushing device 135 in FIG. 2.

Although a preset duration and power for the microwave device, such as device 420, to radiate a mail container, such as container 440, may be suitable and sufficient in most cases, it may be more time and/or energy efficient if the duration of the microwave radiation can optimally be set depending on the weight of the mail container to be radiated. For example, if a mail container, such as 443, is full, its weight in general is heavy. If a mail container, such as 443, is half-full, its weight in general should be medium. If a mail container, such as 443, is almost empty with only a few mail items or pieces, then its weight should generally be light. By determining the weight of a mail container, such as 443, the load level of the mail container may roughly be determined. Therefore, it is beneficial to add a weight-determining device 429 to the apparatus. Although the weight-determining device 429 can be added anywhere in the system, it can easily be integrated with the ingress conveyor device 430a or the rotation device 328.

As shown in FIG. 5, the weight-determining device 429 is integrated with the ingress conveyor device 430a. The weight-determining device 429 is normally in a recessed state so that its top surface 429a aligned with or slightly below the top surface 431a of the ingress conveyor device 430a. The weight-determining device 429 has also a position sensor 429b to determine if a mail container, such as container 442, is on top of its top surface 429a. When a mail container has been transported to the position where the weight-determining device 429 is located, such as mail container 442 in FIG. 5, the position sensor 429b sends a signal to a system control device that may be the same as or similar to system control devices 60, 160, or 260 to report that a mail container is ready to be weighed. The system control device, such as 60, 160, or 260 will then send a control signal to the weight-determining device 429 so that the device 429 will raise itself and determine the weight of the mail container on top of its surface 429a, such as mail container 442 in FIG. 5. The weight of the incoming mail container, such as 442, is then reported to the system control device, such as a system control device similar to 60, 160 or 260, so that the system control device, similar to 60, 160, or 260, can set the optimum radiation duration of the microwave device 420 for the mail container, such as 442.

The weight-determining device 429 may also be integrated with the rotation device 328 of FIGS. 4A and 4B. In that case, the combined device will first determine the weight of the incoming mail container and then rotate it.

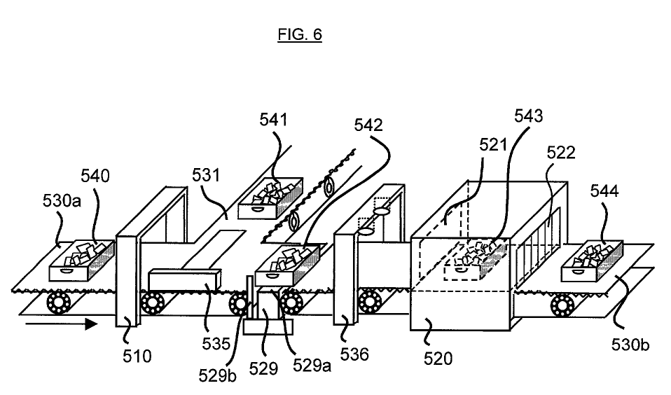

FIG. 6 shows a perspective view of a range-sensing device 536 which may be used to determine the fullness of an incoming mail container, such as containers 540, 541, 542, 543, and 544. FIG. 6 also shows metal detection device 510, microwave device 520 having ingress door 521 and egress door 522, conveyor devices 530a and 530b, and 531, pushing device 535, weighing device 529, which may be similar or the same as similarly numbered and/or similarly named components in prior embodiments of the present invention.

The range-sensing device 536 may be used to determine the fullness of an incoming mail container, such as container 540, as shown in FIG. 6. The range-sensing device 536 can be employed after the metal detection device 510. The range sensing device 536 can determine the average height of the mail items in an incoming mail container, such as container 540. The average height of the mail items in a mail container indicates the fullness of the mail container. The range-sensing device 536 sends a signal reporting the fullness of the incoming mail container, such as container 540 to the system control device which may be similar to 60, 160, or 260 shown in previous embodiments, so that the system control device, similar to 60, 160, or 260 can determine the optimum radiation duration of the microwave device 520 for a mail container, such as container 540.

The microwave devices 20 and 120 shown in FIG. 1 and FIG. 2 may further be improved for enhanced homogeneity of the radiation. For a better homogeneous radiation of microwaves, a plurality of microwave generation devices may be used instead of just one as implemented in most microwave ovens for home cooking purposes. A plurality of microwave generation devices offers the following three advantages:

(1) Due to spatially distributed multiple microwave generation devices, the mail items in a mail container may be radiated more evenly.

(2) If more microwave power is needed to kill the bacteria and viruses, only more microwave generation devices need to be added. No special high-powered microwave generation devices need to be developed and manufactured. By putting a certain number of the commercially available microwave generation devices into one microwave device, sufficient microwave power may be generated for killing the bacteria and viruses in mail items. This makes the production of the apparatus less time-consuming and relatively inexpensive.

(3) Because a plurality of microwave generation devices is used for generating a certain amount of microwave radiation, the failure of one microwave generation device may be tolerated. For example, if ten microwave generation devices are used in an apparatus and eight microwave devices are enough to kill bacteria and viruses, the apparatus may work fine even though two of its microwave generation devices are not working. This makes the maintenance of the apparatus less expensive and frequent.

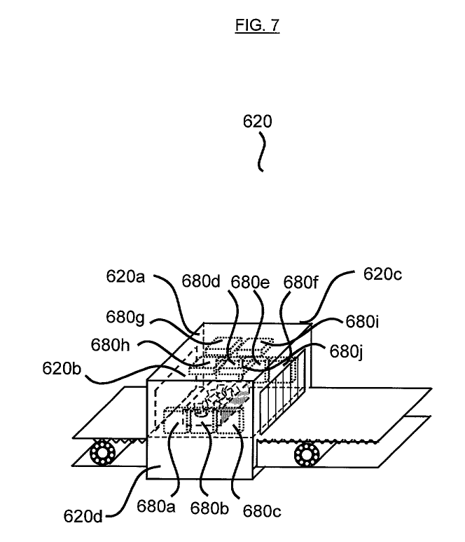

FIG. 7 shows a perspective view of a microwave device 620 which includes a plurality of microwave generation devices, 680a, 680b, 680c, 680d, 680e, 680f, 680g, 680h, 680i, and 680j, placed at different locations. The microwave device 620 can be used in place of the microwave devices 20 and 120 of previous embodiments. The microwave device 620 may also contain a smoke/fire detection device, a fire extinguishing device, and a temperature sensing device, similar to those shown in FIG. 3. However, for a better clarity of the illustration, those devices are omitted in FIG. 7. As shown in FIG. 7, the microwave generation devices 680a-680j may be placed on, for example three of the six walls of a chamber 620a of the microwave device 620. For example, devices 680a-680c may be on a side wall 620d, devices 680d-68f may be on a side wall 620c, and devices 680g-680j may be on a ceiling wall 620b. In operation, all or part of the microwave generation devices 680a-680j may be turned on depending on the amount of mail items in the mail container to be radiated. If the mail container is only half-full, some of the microwave generation devices may be switched off. Certainly, it may be important to turn on or off microwave generation devices in consideration of their spatial locations. Not all microwave generation devices on one wall or at one particular location should be turned off. In general, the devices to be turned off should be as widely distributed as possible.

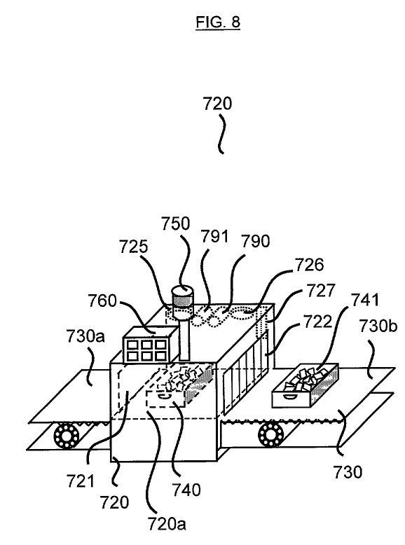

The microwave device 20 and 120 shown in FIG. 1 and FIG. 2 may further be improved for better killing bacteria and viruses on the surface of the mail items in the mail container to be radiated by microwaves. FIG. 8 shows a perspective view of a microwave device 720 which includes, in addition to components similar to or the same as those shown in FIG. 3 and FIG. 7, a steam generation device 790 and an air exchange device 791. The microwave device 720 can be used in place of the microwave devices 20 and 120. The microwave device 720 may also contain a smoke/fire detection device 725, a fire extinguishing device 726, a temperature sensing device 727, an ingress door 721 and an egress door 722 similar to devices 225, 226, 227, 221 and 222 shown in FIG. 3. For a better clarity of the illustration, microwave generation devices, as shown in FIG. 7 are omitted in FIG. 8. FIG. 8 also shows conveyor devices 730a and 730b which may be similar to or the same as conveyor devices 130a and 130b, system state indication device 750 which may be similar to or the same as system state indication devices 50 or 150, and system control device 760 which may be similar to or the same as system control devices 60 or 160. Mail container 740 (shown in dashed lines inside chamber 720a of the microwave device 720) and mail container 741 shown outside the chamber 720a of the microwave device 720 may be the same or similar to previous mail containers.

In operation, before the microwave device 720 starts to radiate the mail items in the mail container 740 located inside of the microwave device 720, the steam generation device 790 generates and pumps a certain amount of steam into the chamber 720a of the microwave device 720 for moisturizing the air inside. The amount of steam may be controlled in such a way that only the surface of the mail items may be slightly moisturized without altering of the appearance of the mail items. After the air inside the chamber 720a of the microwave device 720 is moisturized, the microwave device 720 starts to radiate the mail items in the mail container 740. The water droplets in the moisturized air may easily be heated by the microwave energy. When they are in contact with the bacteria and viruses on the surface of any mail items, the bacteria and viruses may quickly be killed. After the microwave radiation is finished, the air exchange device 791 will be turned on to quickly suck the moisturized air out of the chamber 720a of the microwave device 720, and then pump dry air into the chamber 720a to dry the surface of the mail items and at same time cool the radiated mail items down to a normal temperature.

I claim:

1. An apparatus comprising
a microwave device;
a metal detection device;
wherein the metal detection device determines whether a mail item contains metal;
wherein if the metal detection device determines that a mail item does not contain metal, the microwave device radiates the mail item.

2. The apparatus of 1 further comprising
a conveyor device; and
wherein the conveyor device transports the mail item into the microwave device, so that the mail item can be radiated, only if the metal detection device determines that the mail item does not contain metal.

3. The apparatus of claim 1 wherein
the microwave device has an ingress door for receiving a plurality of mail items in a mail container.

4. The apparatus of claim 3 wherein
the microwave device has an egress door for outputting the mail container after it has been subject to radiation by the microwave device.

5. The apparatus of claim 1 wherein
the microwave device radiates a mail container comprised of a plurality of mail items, if there are no mail items having metal in the mail container; and wherein
the microwave device is comprised of
a rotation device that rotates the mail container as the microwave device radiates the mail container.

6. The apparatus of claim 1 further comprising
an ingress conveyor device for transporting a mail container comprised of a plurality of mail items into the microwave device, so that the microwave device can radiate the mail container.

7. The apparatus of claim 6 further comprising
an egress conveyor device for transporting the mail container out of the microwave device, after the mail container has been radiated.

8. The apparatus of claim 1 further comprising
a bypass conveyor device for transporting the mail item away from the microwave device, when the metal detection device detects that the mail item contains metal.

9. The apparatus of claim 8 further comprising
a pushing device for pushing the mail item with detected metal onto the bypass conveyor device.

10. The apparatus of claim 1 wherein
the microwave device is comprised of
a smoke detection device that detects smoke within the microwave device.

11. The apparatus of claim 1 wherein
the microwave device is comprised of
a fire detection device that detects fire within the microwave device.

12. The apparatus of claim 1 wherein
the microwave device is comprised of
a chamber which is substantially enclosed within the microwave device;
a temperature detection device that monitors the temperature of the chamber; and
wherein a mail item which does not contain metal is radiated within the chamber of the microwave device.

13. The apparatus of claim 1 wherein
the microwave device is comprised of
a fire extinguishing device that extinguishes fire within the microwave device.

14. The apparatus of claim 1 further comprising
a weight-determining device that determines the weight of a mail container comprised of a plurality of mail items.

15. The apparatus of claim 1 further comprising
a range sensing device that determines the average height of each of a plurality of mail items in a mail container.

16. The apparatus of claim 1 wherein
the microwave device is comprised of
a steam generation device that generates and pumps a certain amount of steam into the chamber of the microwave device.

17. The apparatus of claim 1 wherein
the microwave device is comprised of
an air exchange device that sucks moisturized air out of the chamber of the microwave device and then pumps dry air into the chamber.

18. A method comprising the steps of
determining whether a mail item contains metal; and
radiating the mail item if the mail item does not contain metal.

19. The method of claim 18 wherein
the mail item is radiated with microwave radiation if the mail item does not contain metal.

20. The method of claim 18 further comprising
transporting the mail item away from a source of radiation if the mail item contains metal.

21. The method of claim 18 wherein
the mail item is one of a plurality of mail items which are located in a mail container;
and wherein the mail container is radiated if the plurality of mail items do not contain metal.

22. The method of claim 21 wherein
during the step of radiating the mail container, the mail container is rotated.

23. The method of claim 21 further comprising
transporting the mail container into a microwave device so that the microwave device can radiate the mail container.

24. The method of claim 23 further comprising
transporting the mail container out of the microwave device, after the mail container has been radiated.

25. The method of claim 18 further comprising
detecting smoke while the mail item is being radiated.

26. The method of claim 18 further comprising
detecting fire while the mail item is being radiated.

27. The method of claim 18 wherein
the mail item is radiated in a chamber which is substantially enclosed within a microwave device; and further comprising the step of
monitoring the temperature in the chamber.

28. The method of claim 18 wherein
the mail item is radiated in a chamber which is substantially enclosed within a microwave device; and further comprising the step of
providing a fire extinguishing device to extinguish a fire within the chamber.

29. The method of claim 18 wherein
the mail item is one of a plurality of mail items located in a mail container;
the mail item is radiated in a chamber which is substantially enclosed within a microwave device; and further comprising the step of
providing a weight-determining device that determines the weight of the mail container.

30. The method of claim 18 wherein
the mail item is one of a plurality of mail items located in a mail container;
and further comprising the step of
providing a range sensing device that determines the average height of each of a the plurality of mail items.

31. The method of claim 18 wherein
the mail item is radiated in a chamber which is substantially enclosed within a microwave device; and further comprising the step of
generating and pumping a certain amount of steam into the chamber.

32. The method of claim 18 wherein
the mail item is radiated in a chamber which is substantially enclosed within a microwave device; and further comprising the step of
sucking moisturized air out of the chamber of the microwave device and then pumping dry air into the chamber.
